(19) United States
(12) Patent Application Publication
(10) Pub. No.: US 2026/0256563 A1
(43) Pub. Date: Sep. 3, 2026

(54) MAXILLO-MANDIBULAR MEASUREMENT TOOL

(71) Applicant: University of Pittsburgh - Of the Commonwealth System of Higher Education, Pittsburgh, PA (US)

(72) Inventors: Jesse A. Goldstein, Pittsburgh, PA (US); Justin Beiriger, Pittsburgh, PA (US)

(73) Assignee: University of Pittsburgh - Of the Commonwealth System of Higher Education, Pittsburgh, PA (US)

(21) Appl. No.: 18/878,637

(22) PCT Filed: Jun. 26, 2023
(86) PCT No.: PCT/US2023/069093

§ 371 Date: Dec. 23, 2024

Related U.S. Application Data
(60) Provisional application No. 63/356,427, filed on Jun. 28, 2022.

(51) Int. Cl. A61C 19/04

(52) U.S. Cl. CPC A61C 19/04

(57) ABSTRACT

Maxillo-mandibular overjet measurement tools are disclosed herein. In an example, an overjet measurement tool includes a body with a groove and an adjustment member adjustably received within the groove. The overjet measurement tool further includes a first interface and a second interface configured to engage respective portions of a patient's jaw. The second interface is configured to move with the adjustment member such that, when the first and second interfaces contact the patient's jaw, an overjet indicator of the overjet measurement tool indicates an overjet of the patient. In an example, a method includes positioning a first patient interface of a measurement tool against a first portion of a patient's jaw, positioning a second patient interface of the measurement tool against a second portion of the patient's jaw, and measuring an axial distance between the first patient interface and the second patient interface.

### CROSS-REFERENCE TO RELATED APPLICATION

This application claims the benefit of U.S. Provisional Patent Application No. 63/356,427, filed on Jun. 28, 2022, which is incorporated by reference herein in its entirety.

### FIELD

The present disclosure relates to clinical tools for measuring the overjet of a patient.

### BACKGROUND

Pediatric and adult patients with various craniofacial pathologies can experience restricted growth in the mandible and/or maxilla. This restricted growth can result from congenital abnormalities or surgical disruption to growth potential, for example. The overjet of a patient can be an important parameter in determining whether or not surgical correction is desired, and the degree of correction needed. In addition, some procedures involve the advancement of the mandible over time, in which the endpoint is clinically determined when the advancement has alleviated an upper airway obstruction and begun to restore normal dental occlusion. In these patients, the measurement of overjet over time is beneficial to guide both the endpoint and the rate of advancement. Unfortunately, there is no standardized procedure to measure overjet in a clinical setting, and the current methods often employed to measure the overjet can be crude and inaccurate, typically relying on simple rulers, adapted calipers, popsicle sticks, and visual approximations during patient evaluation. Thus, there is a significant need in the field.

### SUMMARY

Described herein are clinical tools for measuring the overjet of a patient, such as maxillo-mandibular measurement tools. The disclosed apparatus and methods can, for example, provide for a simple and quantifiable measurement of the overjet of a patient with a handheld tool that can be adapted for a patient's anatomy. As such, the devices and methods disclosed herein can, among other things, overcome one or more of the deficiencies of typical tools and methods of measuring a patient's overjet.

In a representative example, an overjet measurement tool includes a body with a groove extending through the body along a longitudinal direction and an adjustment member received within the groove. The adjustment member is configured to move axially relative to the body along the longitudinal direction. The overjet measurement tool includes an overjet indicator that indicates a longitudinal position of the adjustment member relative to the body. The overjet measurement tool further includes a first interface extending outwardly from the body and a second interface extending outwardly from the adjustment member. The first interface is configured to contact a first portion of a patient's jaw, and the second interface is configured to contact a second portion of the patient's jaw. The second interface is configured to move axially with the adjustment member relative to each of the body and the first interface such that the second interface can be positioned at various axial positions relative to the body and the first interface. When the first interface contacts the first portion of the patient's jaw and the second interface contacts the second portion of the patient's jaw, the overjet indicator indicates an overjet of the patient.

In a representative example, a method includes positioning a first patient interface of a measurement tool against a first portion of a patient's jaw and positioning a second patient interface of the measurement tool against a second portion of the patient's jaw. The method further includes measuring an axial distance between the first patient interface and the second patient interface. The axial distance between the first and second patient interfaces is associated with an overjet of the patient.

The various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures.

### BRIEF DESCRIPTION OF THE DRAWINGS

FIG. 1A is a top side perspective view of a measurement tool according to an example.

FIG. 1B is an exploded top side perspective view of the measurement tool of FIG. 1.

FIG. 2 is a top side perspective view of a measurement tool with a first patient interface misaligned with a second patient interface according to an example.

FIG. 3 is a top side perspective view of the measurement tool of FIG. 2 with the first patient interface aligned with the second patient interface.

FIG. 4 is a top view of the measurement tool of FIG. 2 with the first and second patient interfaces removed.

FIG. 5 is a rear elevation view of the measurement tool of FIG. 2.

FIG. 6 is a front top side perspective view of the measurement tool of FIG. 2 with the first and second patient interfaces removed.

FIG. 7 is a schematic illustration representing an overjet measurement between a maxilla and a mandible according to an example.

FIG. 8 is a top side perspective view depicting the use of a measurement tool to measure the overjet of a pediatric patient according to an example.

FIG. 9 is a top side perspective view depicting the use of a measurement tool to measure the overjet of an adult patient according to an example.

### DETAILED DESCRIPTION

### General Considerations

For purposes of this description, certain aspects, advantages, and novel features of examples of this disclosure are described herein. The disclosed methods and apparatus should not be construed as being limiting in any way. Instead, the present disclosure is directed toward all novel and nonobvious features and aspects of the various disclosed examples, alone and in various combinations and sub-combinations with one another. The methods and apparatus are not limited to any specific aspect or feature or combination thereof, nor do the disclosed examples require that any one or more specific advantages be present or problems be solved.

Although the operations of some of the disclosed examples are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods and apparatus can be used in conjunction with other methods and apparatus.

As used in this application and in the claims, the singular forms “a,” “an,” and “the” include the plural forms unless the context clearly dictates otherwise. Additionally, the term “includes” means “comprises.” Further, the term “coupled” generally means physically, mechanically, chemically, magnetically, and/or electrically coupled or linked and does not exclude the presence of intermediate elements between the coupled or associated items absent specific contrary language.

As used herein, “e.g.” means “for example,” and “i.e.” means “that is.”

### Examples of the Disclosed Technology

The following description proceeds with reference to the attached figures that are filed herewith, and which are part of the application.

Disclosed herein are examples of tools for measuring the overjet of a patient's jaw and/or bite. As used herein, the term “overjet,” as used to describe a relationship between a patient's maxilla (i.e., upper jaw) and mandible (i.e., lower jaw) generally represents a measurement of an extent to which the maxilla protrudes horizontally beyond the mandible. For example, a patient's overjet may represent a distance by which the patient's upper teeth protrude beyond the patient's lower teeth (e.g., in a forward direction from the patient's point of view). The tools disclosed herein can provide for the measurement of a patient's overjet in a simple, repeatable, and quantifiable manner. As used herein, the disclosed measurement tool additionally or alternatively may be referred to as a clinical tool, a maxillo-mandibular measurement tool, and/or an overjet measurement tool.

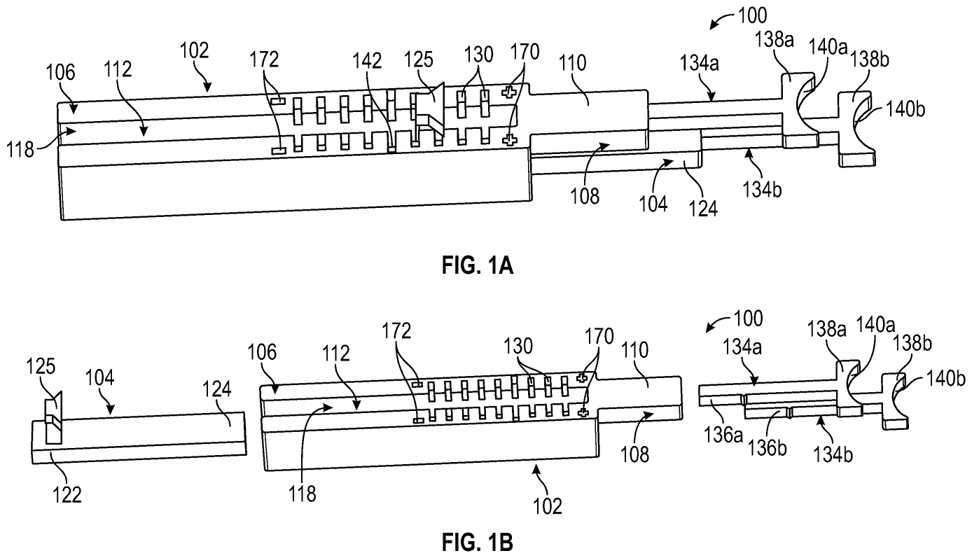

FIGS. 1A-6 illustrate a representative example of a measurement tool 100. As shown in FIGS. 1A-3, the measurement tool 100 can include a housing or body 102 and a slidable or adjustment member 104 moveably coupled to the body 102. The body 102 can include and extend between a first end portion 106 and a second end portion 108. The second end portion 108 can include an elongate portion 110 that extends axially outwardly from a remainder of the body 102 along a direction parallel to a longitudinal axis of the body 102.

In the present disclosure, the term “longitudinal,” as used to describe features of and/or directions relative to the measurement tool 100 and/or a portion thereof, generally refers to a direction extending between the first end portion 106 and the second end portion 108. For example, FIG. 5 illustrates the measurement tool 100 as viewed facing the first end portion 106, and thus may be described as representing a view along the longitudinal axis of the measurement tool 100. In the present disclosure, a longitudinal direction additionally or alternatively may be referred to as an axial direction. Additionally, in the present disclosure, the term “lateral,” as used to describe features of and/or directions relative to the measurement tool 100 and/or a portion thereof, can refer to a direction perpendicular to the longitudinal direction, such as a horizontal direction in the end-on view of FIG. 5.

As shown in FIGS. 1A-6, the body 102 can also include a channel or groove 112 extending from the first end portion 106 to the second end portion 108. The groove 112 can extend within and longitudinally through the body 102 and through the first and second end portions 106, 108.

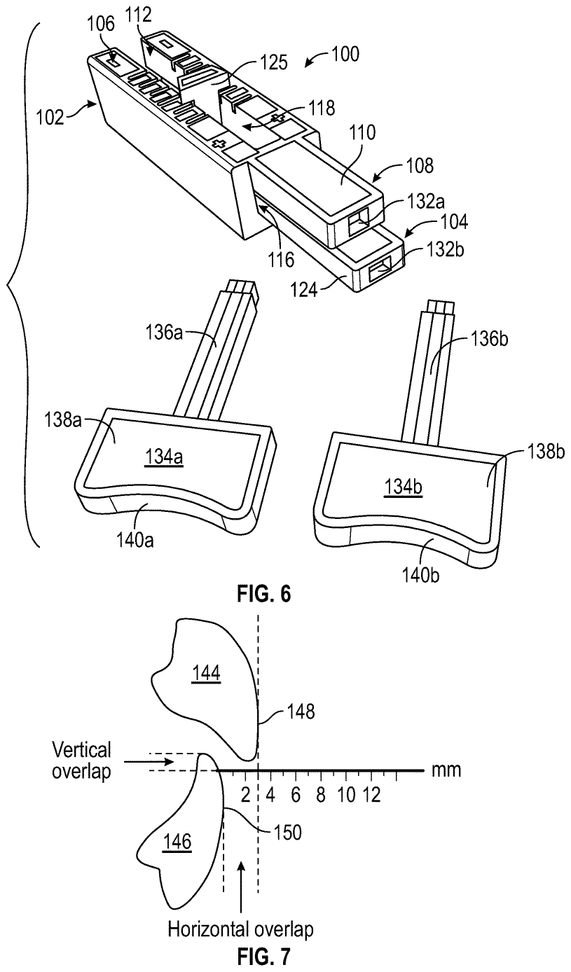

The groove 112 can define, for instance, a first opening 114 (FIGS. 3-5) at the first end portion 106 and a second opening 116 (FIG. 6) at the second end portion 108. Stated differently, the groove 112 can extend fully through the body 102 (e.g., through a longitudinal extent of the body 102) such that the groove 112 is accessible at the first end portion 106 of the body via the first opening 114 and is accessible at the second end portion 108 of the body via the second opening 116.

A slot 118 can extend between the groove 112 and an outer surface 120 of the body 102 (e.g., an upper portion of the outer surface 120 as viewed in FIGS. 1-3 and 5). The slot 118 can, for example, extend from the inner volume of the groove 112 to the outer surface 120. Stated differently, the groove 112 and the slot 118 can correspond to respective portions of a continuous opening or recess defined in the body 102, with the groove extending through a central region of the body 102 between the first end portion 106 and the second end portion 108 and with the slot 118 connecting the groove 112 to the upper portion of the outer surface 120 of the body 102.

The slot 118 can also extend longitudinally and continuously from the edge of the body 102 at the first end portion 106 to the second end portion 108. The slot 118 can terminate at or along the second end portion 108, such as proximate the elongate portion 110. For example, and as shown in FIGS. 1A-3, the elongate portion 110 can define an edge or boundary of the slot 118 proximate the second end portion 108. In some examples, the slot 118 can extend further along the body 102 and along a portion of the elongate portion 110. Stated differently, in such examples, the elongate portion 110 can define a portion of the slot 118. In some examples, and as shown in dashed lines in FIG. 5, the body 102 can also include a groove or recess 121 along the outer surface 120 opposing the slot 118, such as to accommodate a finger, e.g., an index finger, of a user.

As used herein, positional terms such as “above,” “below,” “top,” “bottom,” and the like generally refer to a configuration in which the measurement tool 100 is oriented with the slot 118 positioned at a top and/or upper portion of the body 102 (e.g., such that the slot 118 is positioned above the groove 112). Such descriptions are provided for clarity only and are not to be construed as suggesting or requiring that the measurement tool 100 always be used in a particular orientation.

The adjustment member 104 can include a respective first end portion 122 and a second end portion 124 (FIG. 1B). As shown in FIGS. 1A-6, the adjustment member 104 can be received within and extend into the groove 112 of the body 102. FIG. 5, for example, shows the first end portion 106 of the body 102 and the first end portion 122 of the adjustment member 104 when the adjustment member 104 is situated within the groove 112. The groove 112 can be sized and shaped in such a way as to allow the adjustment member 104 to move or slide axially along and within the groove 112 and relative to the body 102. In this way, the adjustment member 104 can move toward and away from the first and second end portions 106, 108 of the body 102 in a back-and-forth motion. For example, and as shown in FIG. 5, the groove 112 and the adjustment member 104 each can be rectangular in shape (e.g., as viewed along the longitudinal axis of the measurement tool 100), with the groove 112. In other examples, the adjustment member 104 and/or the groove 112 can be nonrectangular in shape (e.g., as viewed along the longitudinal axis of the measurement tool 100).

As shown in FIG. 5, the groove 112 can be sized to receive the adjustment member 104. In particular, in the example of FIG. 5, the groove 112 is sized to receive the adjustment member 104 in a close-fit arrangement, with one or more portions of an inner surface 128 of the groove 112 engaging the adjustment member 104. Such a close-fit arrangement may serve to restrict or prevent the adjustment member 104 from rotating relative to the body 102 when the adjustment member 104 is received within the groove 112. In some examples, the inner surface 128 of the groove 112 can engage the adjustment member 104 such that the adjustment member 104 is frictionally retained in a given position relative to the body 102 until moved away from such a position by a user.

As shown in FIG. 5, a pair of ledges or lips 126 can be defined along the inner surface 128 of the groove 112 and body 102. In the example of FIG. 5, the lips 126 extend toward one another to define a lateral gap therebetween, with the slot 118 extending through the lateral gap. The lateral gap formed by the slot 118 can be relatively narrow in comparison to the lateral width of the groove 112 (e.g., perpendicular to the longitudinal axis of the body 102). For example, and as shown in FIG. 5, the lateral gap formed by the slot 118 can have a slot width 119, and the groove 112 can have a groove width 113 that is greater than the slot width 119. As such, the portion of the body 102 defining the slot 118 defines the lip 126 along the inner surface 128. The lip 126 can, in some instances, act to or otherwise retain the adjustment member 104 within the groove 112 and against lateral and/or rotational movement (e.g., movement along any direction other than along the longitudinal axis of the body 102).

While FIG. 5 illustrates a configuration in which the body 102 includes a pair of lips 126 extending toward one another to define the slot 118 therebetween, this is not required of all examples. For example, it also is within the scope of the present disclosure that the body 102 can include a single lip 126 such that the groove 112 and the slot 118 are not centered relative to one another. In such an example, the groove 112 and the slot 118 can be connected to one another to form a generally L-shaped opening, as viewed along the longitudinal axis of the body 102.

With reference to FIGS. 1A-6, the slot 118 can also be shaped and sized to receive a tab 125 which extends outwardly (e.g., vertically in the view of FIG. 5) from an outer surface of the adjustment member 104. When assembling the measurement tool 100, for instance, the second end portion 124 of the adjustment member 104 can be inserted into the groove 112 and moved axially toward the second end portion 108 of the body 102. As the first end portion 122 of the adjustment member 104 is received within the groove 112, the tab 125 is also received within the slot 118, which is sized and shaped to allow the tab 125 to move axially relative to the body 102 as the adjustment member 104 moves axially along and within the groove 112. In the illustrated example, the tab 125 extends outwardly from an outer surface of the first end portion 122 of the adjustment member 104. In other examples, the tab 125 can extend from any suitable portion of the adjustment member 104, such as from the second end portion 124 or from a region between the first end portion 122 and the second end portion 124.

As shown in FIG. 5, the tab 125 can have a T-like shape including a tab arm 160 and a pair of lateral portions 162 extending laterally outward from the tab arm 160. The lateral portions thus are coupled to the adjustment member 104 via the tab arm 160 and can move with the adjustment member 104 along the outer surface 120 of the body 102. FIGS. 1A-4 also show that the body 102 can have an overjet indicator in the form of a plurality of lateral markings 130. Each lateral marking 130, for instance, can be one of a pair of lateral markings situated on opposing sides of the slot 118 and extending laterally from the slot 118. As will be further described, the relative positioning of the tab 125 to the lateral markings 130 as the adjustment member 104 moves axially relative to the body 102 can be used to read or determine a measurement of the relative positioning between the maxilla and mandible of a patient. In the illustrated example, the lateral markings 130 are formed as notches or indentations in the body 102. In other examples, the overjet indicator can include lateral markings 130 that are be applied to the body 102, such as in the form of markings and/or raised structures. In further examples, the overjet indicator can include any of a variety of markings distributed longitudinally along the body 102 and/or the slot 118, such as dots, shapes, alphabetic characters, numerical characters, etc.

FIGS. 1A-6 and 8-9 show that the measurement tool 100 can also include a pair of patient interfaces 134a, 134b coupled to the body 102 and to the adjustment member 104. A first patient interface 134a can be coupled to the second end portion 108 of the body 102 and a second patient interface 134b can be coupled to the second end portion 124 of the adjustment member 104. As shown in FIG. 6, the second end portion 108 of the body 102 (e.g., the elongated portion 110) can include an aperture or opening 132a configured to receive or otherwise mate with a stem 136a of the first patent interface 134a. Similarly, the second end portion 124 of the adjustment member 104 can include an aperture or opening 132b configured to receive or otherwise mate with a stem 136b of the patient interface 134b. Each stem 136a, 136b and the corresponding opening 132a, 132b can be configured to be coupled to one another via a snap fit and/or other mating connection. In some examples, for instance, the coupling mechanism can be a “snug fit” in which the first and second patient interfaces 134a,134b are positioned and pressed into the openings 132a, 132b of the body 102 and adjustment member 104, respectively. FIG. 6 shows a direct view of the openings 132a, 132b.

In some examples, the first and/or second patient interfaces 134a, 134b can be configured to be selectively and repeatedly inserted into and removed from the corresponding openings 132a, 132b. For example, such a configuration may allow for any of a plurality of differently configured first and/or second patient interfaces 134a, 134b to be used with the measurement tool 100, as described below.

As shown in FIG. 3, when the two interfaces 134a, 134b are aligned or nearly aligned, the elongate portion 110 of the body 102 overlaps the adjustment member 104. In this manner, the elongate portion 110 may be described as being vertically offset from the groove 112 through which the adjustment member 104 extends. In some examples, the elongate portion 110 may be configured to engage the adjustment member 104 and/or to restrict the adjustment member 104 from deflection in a vertical direction, such as to maintain the interfaces 134a, 134b in a vertically spaced-apart configuration.

The stem 136a, 136b of each interface 134a, 134b can be relatively narrow to and extend longitudinally from a respective mouthpiece 138a, 138b. Each mouthpiece 138a, 138b can be relatively planar in shape and situated orthogonally relative to a longitudinal axis of a respective stem 136. Each mouthpiece 138a, 138b can also have a curved surface 140a, 140b that curves inwardly along a lateral edge of the mouthpiece. The curved surfaces 140a, 140b of the mouthpieces 138a, 138b can be configured to receive a respective portion of a patient's anatomy such that the curved surfaces 140a, 140b define a contact interface that directly or indirectly contacts and/or engages the desired anatomy. The curved surfaces 140a, 140b, for example, can be sized and shaped to fit the general contours of a patient's upper and lower jaw. In some examples, the fit between the curvature of the curved surfaces 140a, 140b and respective portions of the patient's jaw can reduce or prevent lateral movement of the measurement tool 100 relative to the patient during overjet measurements. The curved surfaces 140a, 140b can also be designed to contact the gingiva, or the gums overlaying the bony surfaces, of the maxilla and mandible, respectively.

As used herein, the term “jaw” may be understood as referring to any of a variety of portions of the patient's anatomy, as applicable. For example, the term “jaw” can encompass the patient's maxilla (which also may be referred to as the patient's upper jaw) and/or the patient's mandible (which also may be referred to as the patient's lower jaw), and/or any applicable subset of the patient's teeth.

In representative examples, the first and second interfaces 134a, 134b can be a first set of interfaces which are interchangeable with a second set of interfaces. In such examples, the second set of interfaces can be the same as the interfaces 134a, 134b. In other examples, the second set of interfaces can differ in at least one dimension from the first and second interfaces 134a, 134b, such as in width, height, length, and/or curvature. It should be appreciated that the measurement tool 100 can be configured to have a variety of differently configured interfaces and/or sets of interfaces.

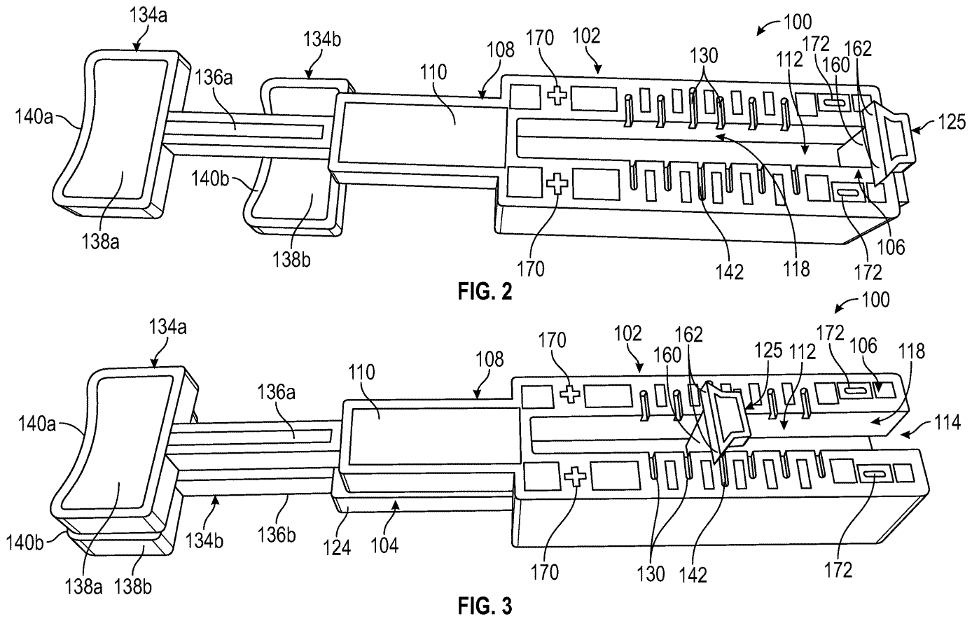

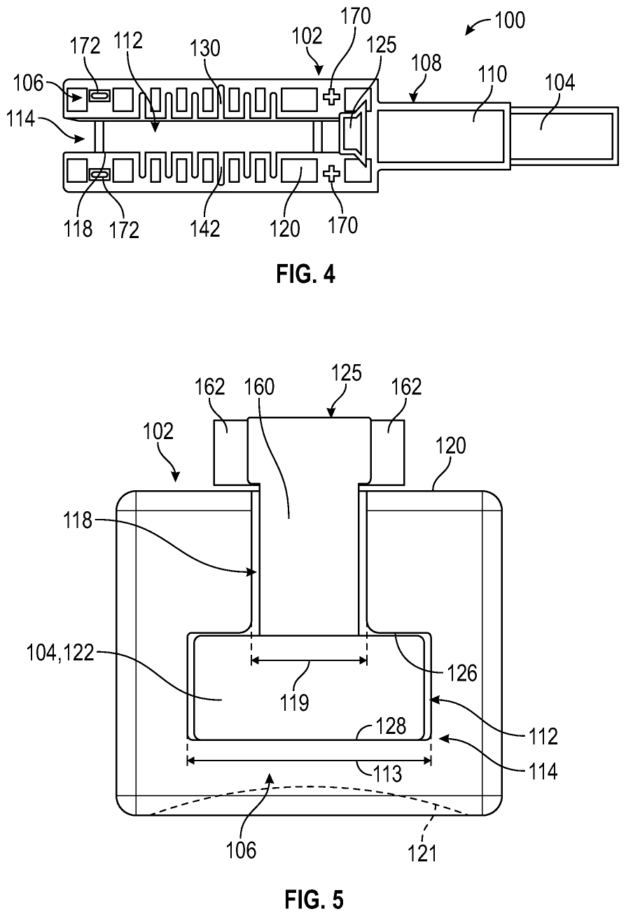

With reference to FIGS. 1A and 2-3, by way of being coupled to the second end portions 108, 124 of the body 102 and adjustment member 104, the second interface 134b is configured to move axially relative to the first interface 134a. For instance, the first interface 134a coupled to the second end portion 108 of the body 102 is stationary relative to the body 102, while the second interface 134b coupled to the second end portion 124 of the adjustment member 104 can move axially relative to the body 102 with the adjustment member 104 as the adjustment member 104 moves axially along the groove 112. This axial motion of the adjustment member 104 and second interface 134b can be effectuated by manipulating the tab 125 of the adjustment member 104 in the direction desired by a user of the measurement tool 100. In this way, the mouthpiece 138b and curved surface 140b of the interface 134b can move toward and away from the second end portion 108 of the body 102 with the corresponding movement of the adjustment member 104. For example, the mouthpiece 138b and curved surface 140b of the interface 134b can be situated axially between the curved surface 140a and the body 102 (e.g., FIG. 2) when the tab 125 is proximate to and/or as the tab 125 approaches the first end portion 106 of the body 102. In a similar manner, the adjustment member 104 and the tab 125 can be directed axially in the direction of the second end portion 108 of the body 102 such that the mouthpiece 138b and curved surface 140b of the interface 134b can be aligned or nearly aligned with the mouthpiece 138a and curved surface 140a of the first interface 134a (e.g., as shown in FIG. 3) or positioned beyond the outermost edge of the mouthpiece 138a (e.g., FIGS. 1A and 4). In some examples, the body 102 can have a longitudinal length such that the tab 125 is situated and retained within the gap defined by the slot 118 when the adjustment member 104 and tab 125 are directed toward the first end portion 106 of the body 102 (e.g., FIG. 2).

As shown in FIG. 3, when the two interfaces 134a, 134b are aligned or nearly aligned, the tab 125 can be positioned at a lateral marking defining an origin or baseline marking 142. The baseline marking 142 can be used to determine or provide the relative axial distance between the curved surfaces 140a, 140b of the first and second interfaces 134a-134b as the adjustment member 104 moves axially along the groove 112. For example, the tab 125 can be stationary relative to the outer surface of the adjustment member 104 and thereby positioned at a set distance relative to the outermost end of the second end portion 124 of the adjustment member 104, which in turn is coupled to the second interface 134b. As the adjustment member 104 and the second interface 134b are moved axially within and relative to the groove 112 in either direction, the tab 125 travels in the same direction and by the same relative axial distance as the mouthpiece 138b and curved surface 140b do relative to the mouthpiece 138a and curved surface 140a of the first interface 134a. As the adjustment member 104 moves along the groove 112, the tab 125 also moves relative to and axially along the slot 118 and lateral markings 130. In this way, the relative positioning of tab 125 with respect to the baseline marking 142 can be read to determine the axial distance between the curved surfaces 140a, 140b. As such, each of the other lateral markings 130 can correspond to a unit distance from the baseline marking 142 to be read by the user (e.g., in millimeters, centimeters, inches, etc.). This measurement between the curved surfaces 140a, 140b can be used to determine the overjet of a patient.

As discussed above, the measurement tool 100 can be configured such that the adjustment member 104 is frictionally retained in a given position relative to the body 102 until moved away from such a position by a user. Additionally or alternatively, in some examples, the measurement tool 100 can include a locking mechanism that operates to selectively retain the adjustment member 104 in position relative to the body 102, such as at a position corresponding to a measurement of the patient's overjet. In such examples, the locking mechanism can be selectively transitioned between a locked configuration, in which the adjustment member 104 is restricted and/or prevented from translating relative to the body 102, and an unlocked configuration, in which the adjustment member 104 is free to translate relative to the body 102 in at least one direction (e.g., at least one longitudinal direction). When present, the locking mechanism can include and/or be any of a variety of mechanisms, examples of which include a cam lock mechanism, a frictional lock mechanism, a button-actuated lock mechanism, a lever-actuated lock mechanism, etc.

Additionally or alternatively, in some examples, the measurement tool 100 can include a ratchet mechanism (or a functional equivalent) that selectively restricts and/or prevents translation of the adjustment member 104 in one longitudinal direction relative to the body 102 while permitting translation in the opposite direction. For example, during use of the measurement tool 100, the first patient interface 134a can be brought into contact with the patient's maxilla, and the ratchet mechanism can allow the second patient interface 134b to be advanced into contact with the patient's mandible but to prevent the adjustment member 104 to be retracted away from the patient's mandible until the ratchet mechanism is disabled.

In such examples, the retention and/or locking of the adjustment member 104 relative to the body 102 can facilitate the measurement of the patient's overjet without requiring that the measurement tool 100 be observed while the measurement tool 100 contacts the patient's jaw. For example, the patient interfaces 134a, 134b of the measurement tool 100 can be brought into contact with the patient's jaw, and the adjustment member 104 can be retained and/or locked in position relative to the body 102 to allow for the measurement tool 100 to be removed from the patient's jaw in order to read and/or record the overjet measurement. Such features similarly can facilitate operation of the measurement tool 100 by the patient alone, such that the patient can perform the measurement and read the results without inadvertently changing the overjet measurement represented by the measurement tool 100.

The overjet of a particular patient can be determined by measuring the horizontal overlap of the maxilla over the mandible, i.e., the respective horizontal misalignment. In particular, the overjet can be determined by a one-dimensional measurement in the anterior-posterior direction, which measures the relative axial distance between the alveolar and/or maxillary central incisors of the patient, over the mandibular central incisors. FIG. 7 illustrates an example of one such overjet measurement. For instance, the horizontal overlap of the maxilla 144 over the mandible 146 can determined by measuring the relative distance between the anterior surface 148 of the maxilla 144 and the anterior surface 150 of the mandible 146. The depicted overjet shown in FIG. 7, for example, is equal to approximately 3 mm. Since the maxilla 144 extends over the mandible 146, this overjet measurement of can be considered a positive overjet value. Conversely, when the maxilla 144 is posterior to the mandible 146, the overjet measurement can be considered a negative overjet value.

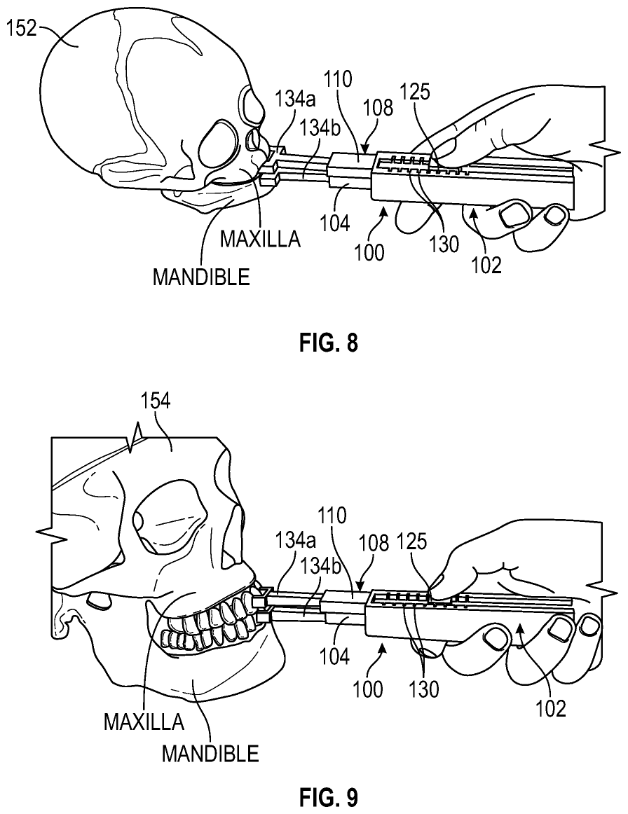

FIGS. 8 and 9 demonstrate how the measurement tool 100 described herein can be employed to measure the overjet of both pediatric and adult patients alike. Specifically, FIG. 8 is representative of an overjet measurement of a pediatric patient 152, while FIG. 9 is representative of an overjet measurement of an adult patient 154. As shown in FIGS. 8-9, to measure the overjet of a particular patient, the measurement tool 100 can be positioned such that the curved surface 140a of the first interface 134a contacts the alveolar (e.g., FIG. 8) and/or the upper incisors (e.g., FIG. 9) of the patient. By using the tab 125 (e.g., by translating the tab 125 relative to the body 102), the user can move the adjustment member 104 and thereby the second interface 134b axially relative to the first interface 134a to position the curved surface 140b of the second interface 134b in contact with the mandible (e.g., the lower incisors). While the curved surfaces 140a, 140b are in contact with the maxilla and mandible, or once the relative positioning between the interfaces 134a, 134b is established, the overjet measurement can be read by looking at the position of the tab 125 relative to the baseline marking 142 and/or the other lateral markings 130. As described, this measurement corresponds to the axial distance between the curved surfaces 140a, 140b of the interfaces 134a, 134b which were in contact with respective portions of the patient's anatomy. In some examples, the accuracy and/or precision of this measurement can be within 0.5 mm or less of the precise overjet.

As shown in FIGS. 8-9, the measurement tool 100 may be configured for single-handed operation by a user (e.g., by the patient 152/154 or by an individual other than the patient). In particular, the measurement tool 100 may be configured such that the user can grasp the body 102 in one hand while manipulating the tab 125 with the thumb of the same hand, thereby leaving the remaining hand free for tasks such as exposing the patient's jaw.

In examples in which a positive overjet value corresponds to the maxilla extending over the mandible, the markings 130 situated between the baseline marking 142 and interfaces 134 can be labeled as positive unit measurements. As shown in FIGS. 1A-4, such positive unit measurements can be indicated by a positive overjet indicator 170, which in this example takes the form of a plus sign (“+”). By extension, those markings 130 situated between the baseline marking 142 and the first end portion 106 of the body 102 can be labeled as negative unit measurements. As shown in FIGS. 1A-4, such negative unit measurements can be indicated by a negative overjet indicator 172, which in this example takes the form of a negative sign (“−”). In such examples, when the curved surface 140b of the second interface 134b is positioned beyond the curved surface 140a of the first interface 134a, i.e., positioned at a relatively greater axial distance from the body 102, the relative positioning of the interfaces 134a, 134b can be said to correspond to a positive overjet value.

Likewise, when the curved surface 140b of the second interface 134b is positioned between the curved surface 140a and the body 102, the relative positioning of the interfaces 134a, 134b can be said to correspond to a negative overjet value. It should be appreciated that the positive and negative values and their markings can be reversed from what is described and shown.

In representative examples, the interfaces 134a, 134b can vary in at least one dimension depending on a particular patient. For instance, the mouthpieces 138a, 138b and curved surfaces 140a, 140b of the interfaces 134a, 134b for a pediatric patient can be relatively narrower and/or relatively shallower, respectively, in comparison to the mouthpieces and curved surfaces for an adult patient. By extension, the mouthpieces 138a, 138b and curved surfaces 140a, 140b for an adult patient can be relatively wider and/or have a depth relatively greater than the mouthpieces and curved surfaces for a pediatric patient. Accordingly, and as discussed above, the interfaces 134a, 134b can be configured to be selectively coupled to and removed from the body 102 and the adjustment member 104 such that the body 102 and the adjustment member 104 can be used with any of a variety of sets of interfaces 134a, 134b depending upon the specific use case (e.g., patient anatomy).

In some examples, the first and second interfaces 134a, 134b can have the same dimensions, while in other examples, one interface can differ in at least one dimension from the other. In some examples, the mouthpieces 138 can have a width ranging from 0.25 cm to 8 cm and a height ranging from 0.01 cm to 4 cm. A width ranging from 1 cm to 4 cm and a height ranging from 0.2 cm to 2 cm being specific examples. In some examples, the width and/or height of the mouthpieces 138 can be adjustable. For instance, the mouthpieces can include two or more movable pieces which can increase and/or decrease the overall width or height of the mouthpiece.

The curved surfaces 140, in some examples, can have a radius of curvature ranging from 0.25 cm to 35 cm, with a radius of curvature ranging from 2 cm to 25 cm being specific examples. The interfaces can also have a total length ranging from 4 cm to 7 cm, with a length ranging from 5 cm to 6 cm being specific examples. The length of the interfaces 134, for example, via the length of the stems 136, can provide a desired or adequate spacing between the patient and the body 102 of the measurement tool 100. This spacing between the body 102 and the patient, for example, can prevent bodily fluids, such as saliva, from getting on the adjustment member 104 or other portions of the measurement tool 100. The extended length of the interfaces 134 and mouthpieces 138 can also assist the user in taking overjet measurements of intubated patients and/or patients under anesthesia.

In further examples, the body 102, adjustment member 104, and/or the interfaces 134a, 134b of the measurement tool 100 can be composed of one or more materials which allow the components to be disposable, 3D printed, and/or sterilizable. For example, any one of the components can be made of polylactic acid (PLA) or another like material favorable for disposable use and/or to produce the components via additive manufacturing. Using PLA can, in some examples, also make any one of the components biodegradable, for more effective disposal. Sterilizable materials can be used in both clinical and surgical settings, for example, intraoperatively, and can include a stainless steel, nylon 12, surgical resins, and/or polyetheretherketone (PEEK). Stainless steel, for instance, can be cleaned and sterilized multiple times for use across different patients. Nylon 12 can be used in additive manufacturing, especially in localized applications in hospitals, and can be sterilized much like stainless steel. Similarly, surgical resins and PEEK can also be used in additive manufacturing and be sterilized for use intraoperatively.

The specific examples disclosed herein are not limiting of the invention, but rather are examples of a broad array of different examples that the inventors have envisioned that include the technology disclosed herein. Any of the features or characteristics disclosed herein can be combined in any way with any other features or characteristics disclosed herein, as well as with any other known technology, to form a variety of different examples that include or relate to the inventive technology disclosed herein.

In view of the many possible ways in which the principles of the disclosure may be applied, it should be recognized that the illustrated configurations depict examples of the disclosed technology and should not be taken as limiting the scope of the disclosure nor the claims. Rather, the scope of the claimed subject matter is defined by the following claims and their equivalents.

1. An overjet measurement tool, comprising:
a body comprising a groove extending through the body along a longitudinal direction;
an adjustment member received within the groove and configured to move axially relative to the body along the longitudinal direction;
a first interface extending outwardly from the body and configured to contact a first portion of a patient's jaw; and
a second interface extending outwardly from the adjustment member and configured to contact a second portion of the patient's jaw; and
an overjet indicator that indicates a longitudinal position of the adjustment member relative to the body,
wherein the second interface is configured to move axially with the adjustment member relative to each of the body and the first interface such that the second interface can be positioned at various axial positions relative to the body and the first interface, and
wherein, when the first interface contacts the first portion of the patient's jaw and the second interface contacts the second portion of the patient's jaw, the overjet indicator indicates an overjet of the patient.

2. The overjet measurement tool of claim 1, wherein the first interface is configured to be selectively and repeatedly coupled to and removed from the body.

3. The overjet measurement tool of claim 1, wherein the second interface is configured to be selectively and repeatedly coupled to and removed from the adjustment member.

4. The overjet measurement tool of claim 1, further comprising a third interface and a fourth interface, wherein the first and the second interfaces form a first set of interfaces and the third and fourth interfaces form a second set of interfaces, and wherein the first and second sets of interfaces are interchangeable.

5. The overjet measurement tool of claim 1, wherein the first and second interfaces have respective curved surfaces to receive respective portions of the patient's jaw.

6. The overjet measurement tool of claim 1, further comprising a tab extending away from the adjustment member, wherein the overjet indicator comprises a plurality of markings longitudinally distributed along the body, and wherein a position of the tab relative to the markings of the body corresponds to the overjet of the patient.

7. The overjet measurement tool of claim 6, wherein the body defines a slot extending between the groove and an outer surface of the body, and wherein the tab comprises a tab arm extending at least partially through the slot.

8. The overjet measurement tool of claim 7, wherein the slot has a slot width, as measured along a lateral direction perpendicular to the longitudinal direction, and wherein the groove has a groove width, as measured along the lateral direction, that is greater than the slot width.

9. The overjet measurement tool of claim 7, wherein the tab comprises one or more lateral portions extending laterally outward from the tab arm, and wherein a position of the one or more lateral portions relative to the overjet indicator indicates the overjet of the patient.

10. The overjet measurement tool of claim 1, wherein the body comprises a first end portion and a second end portion, wherein the second end portion comprises an elongate portion that extends axially outwardly from a remainder of the body and that is vertically offset from the groove, and wherein the first interface is coupled to the elongate portion.

11. The overjet measurement tool of claim 10, wherein the elongate portion overlaps the adjustment member to maintain the first and second interfaces in a spaced-apart configuration relative to one another.

12. The overjet measurement tool of claim 1, wherein the adjustment member engages the body such that the adjustment member is frictionally retained in a given position relative to the body until deliberately moved by a user.

13. A method, comprising:
positioning a first patient interface of a measurement tool against a first portion of a patient's jaw;
positioning a second patient interface of the measurement tool against a second portion of the patient's jaw; and
measuring an axial distance between the first patient interface and the second patient interface, wherein the axial distance between the first and second patient interfaces is associated with an overjet of the patient.

14. The method of claim 13, wherein positioning the second patient interface comprises:
while the first patient interface is against the first portion of the patient's jaw, moving the second patient interface axially relative to the first patient interface and a body of the measurement tool to position the second patient interface against the second portion of the patient's jaw.

15. The method of claim 13, wherein the first portion of the patient's jaw is an upper jaw of the patient and the second portion of the patient's jaw is a lower jaw of the patient.

16. The method of claim 13, the method further comprising:
coupling the first patient interface to a body of the measurement tool, wherein the first patient interface extends outwardly from the body; and
coupling the second patient interface to an adjustment member of the measurement tool, wherein the second patient interface extends outwardly from the adjustment member and the adjustment member is movably coupled to the body, and wherein the second patient interface and adjustment member are configured to move axially relative to the body and the first patient interface.

17. The method of claim 13, the method further comprising:
removing the first patient interface from the measurement tool and replacing the first patient interface with a third patient interface; and
removing the second patient interface from the measurement tool and replacing the second patient interface with a fourth patient interface.

18. The method of claim 13, wherein the measuring the axial distance between the first and second patient interfaces comprises:
measuring an axial distance between a first curved surface of the first patient interface and a second curved surface of the second patient interface.

19. The method of claim 13, wherein the first patient interface is fixedly coupled to a body of the measurement tool, wherein the second patient interface is fixedly coupled to an adjustment member of the measurement tool that is longitudinally movably received within the body, and wherein the measuring the axial distance between the first and second patient interfaces comprises comparing a longitudinal position of the adjustment member to an overjet indicator on the body.

20. The method of claim 13, wherein the first patient interface is fixedly coupled to a body of the measurement tool, wherein the second patient interface is fixedly coupled to an adjustment member of the measurement tool that is longitudinally movably received within the body, wherein the measurement tool comprises a tab extending away from the adjustment member, and wherein one or both of the positioning the first patient interface and the positioning the second patient interface comprises translating the tab relative to the body while holding the body in position relative to the patient's jaw.
